(19) United States
(12) Patent Application Publication
(10) Pub. No.: US 2005/0232266 A1
(43) Pub. Date: Oct. 20, 2005

(54) Communication device and communication method

(75) Inventor: Yoshifumi Tanimoto, Osaka (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: Murata Kikai Kabushiki Kaisha, Kyoto-shi (JP)

(21) Appl. No.: 11/104,439

(22) Filed: Apr. 13, 2005

(30) Foreign Application Priority Data
Apr. 15, 2004 (JP) 2004-120512

(51) Int. Cl. H04L 12/28; H04L 12/66

(52) U.S. Cl. 370/389; 370/400

(57) ABSTRACT

A communication device includes an IP address acquiring unit, an identifier transmitting unit and a substantial data transmitting unit. The IP address acquiring unit acquires an IP address by presenting a domain name of a destination communication device by using a DNS service. The identifier transmitting unit establishes a connection with the destination communication device assigned with the acquired IP address and transmits an identifier assigned statically to the domain name of the destination communication device. The substantial data transmitting unit transmits substantial data to the destination communication device in case of receiving a reception permission response for the identifier from the destination communication device.

### BACKGROUND OF THE INVENTION

1. Field of the Invention

The present invention relates to a communication device which carries out a peer-to-peer Internet Protocol (IP) communication. The present invention relates more specifically to a transmitter communication device, which presents a destination domain name to acquire an IP address by using a Domain Name System (DNS) service or a dynamic DNS service and transmits data to the acquired IP address, and a recipient communication device, which receives the data.

2. Description of Related Art

In case of carrying out a data communication with a destination, a communication device, which carries out an IP communication, may acquire a destination IP address by using a dynamic DNS service. The dynamic DNS service is realized by an interaction of a dynamic DNS server and a Dynamic Host Configuration Protocol (DHCP) server, which supports a dynamic DNS. The dynamic DNS server transfers information in both directions with the DHCP server as needed and adds or deletes information of a domain name of a DHCP client and an IP address of the DHCP client in a zone file of a DNS server. Accordingly, the latest IP address assigned dynamically by the DHCP server is presented to a communication device, which is to be the DNS client. Therefore, even in case the IP address assigned to the domain name of a destination communication device is a dynamic IP address, a connection can be established with the destination communication device having the domain name and a data communication can be carried out.

In case of transmitting data to the IP address acquired by the dynamic DNS service, there are cases in which a connection is established mistakenly with a communication device having a domain name that is different from the destination domain name presented to the DNS server and the data is transmitted. A description will be made of such cases by referring to an example shown in FIG. 3 of a network environment including a dynamic DNS service 18 (a dynamic DNS server 18a and a DHCP server 18b), routers 19 through 21 and communication devices 25 through 27 respectively connected to the routers 19 through 21 on the Internet 17.

As shown in FIG. 4, an IP address X is already assigned by the dynamic DNS service 18 (the DHCP server 18a) (step S1). In case the communication device 25 transmits data to the communication device 26 connected to the router 20, the communication device 25 presents a domain name of the router 20 (the communication device 26) to the dynamic DNS server 18a and acquires the IP address X assigned to the presented domain name (step S2). Then, for example, data such as electronic mail is transmitted to the acquired IP address X (step S3).

In case processing operations (steps S4 through S6) as shown in FIG. 4 are generated during a period of time from when the communication device 25 acquires the IP address X (step S2) until when a data transmission (step S3) is started, a problem generates. That is, during the abovementioned period of time, in case an error or the like generates in the router 20 and an access of the router 20 and the dynamic DNS service 18 (the DHCP server 18a) is disconnected (step S4), the dynamic DNS service 18 (the DHCP server 18a) sets the IP address X assigned to the router 20 under an available state (step S5). Then, in case the other router 21 establishes a connection with the dynamic DNS service 18 (the DHCP server 18a) and receives an assignment of the IP address X under an available state (step S6), the communication device 25 mistakenly transmits data to the communication device 27, which is connected to the router 21 and is a same type as the communication device 26.

Even in case of transmitting the data to a static IP address acquired by a static DNS service, an IP address of the destination communication device may be changed by a change in a setting or the like of the destination communication device.

### SUMMARY OF THE INVENTION

The present invention has been made in consideration of the above-described circumstances. An advantage of the present invention is to provide a communication device which can prevent an error transmission that is generated due to a destination communication device assigned with an IP address acquired by a DNS service being switched during a period of time from when the IP address is acquired until when a connection is established with the destination communication device.

### BRIEF DESCRIPTION OF THE SEVERAL VIEWS OF THE DRAWINGS

FIG. 1 shows an example of a configuration of a facsimile Multi Function Peripheral (MFP) (a communication device) and an example of a network environment when a plurality of facsimile MFPs (communication devices) carry out a data communication by using a dynamic DNS service, according to an embodiment of the present invention.

FIG. 2 is a flowchart showing a processing operation executed when facsimile MFPs (communication devices) transmit and receive data, according to an embodiment of the present invention.

FIG. 3 shows an example of a network environment for describing a problem that is generated when conventional communication devices carry out a data communication by using a dynamic DNS service.

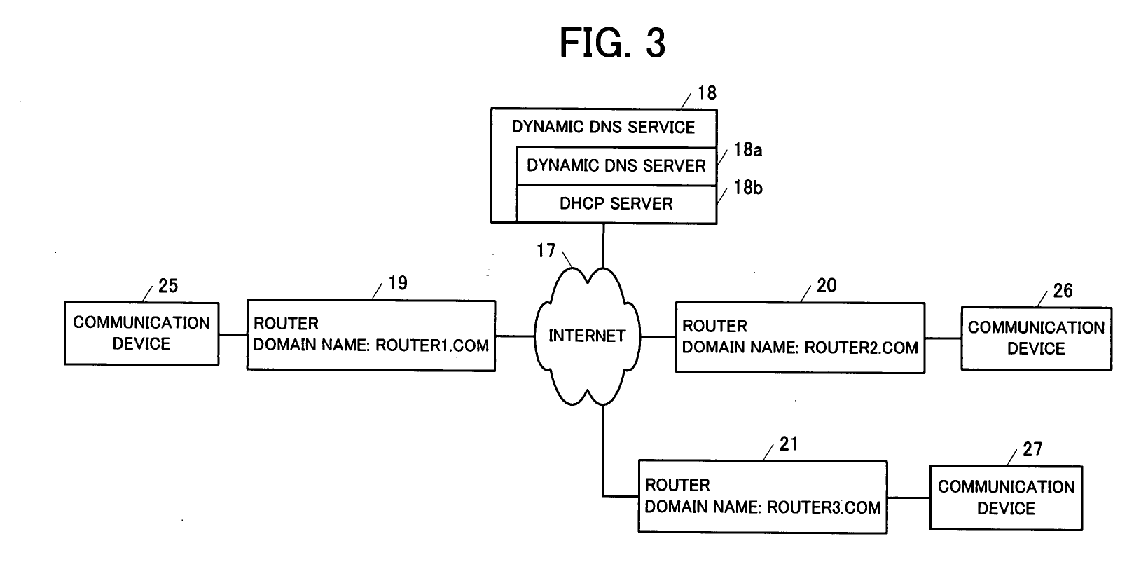

FIG. 4 shows an example of a processing procedure that becomes a problem when conventional communication devices carry out a data communication by using a dynamic DNS service.

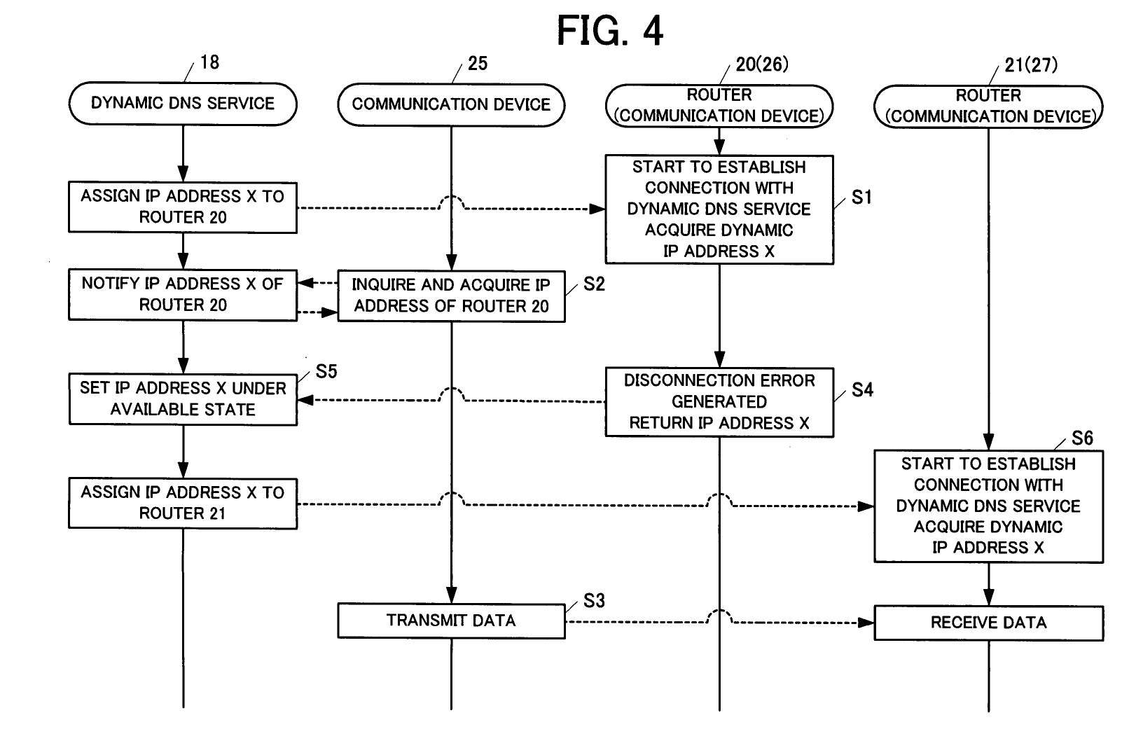

### DETAILED DESCRIPTION OF THE INVENTION

A description will be made of an example of a facsimile MFP having a G3 facsimile communication function and an Internet facsimile communication function as a communication device according to an embodiment of the present invention. The present invention is not limited to the abovementioned facsimile MFP and can also be applied to another type of communication device if the communication device establishes a connection directly with a destination by an IP address and carries out a peer-to-peer data communication.

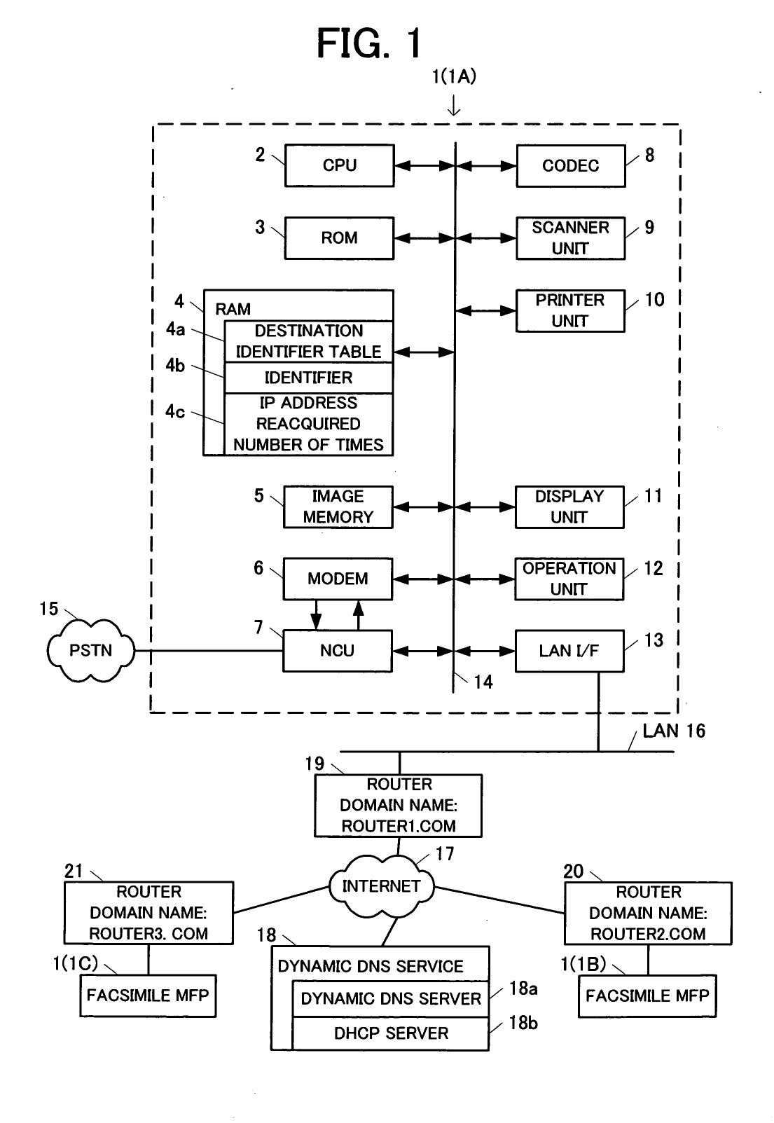

FIG. 1 shows an example of a configuration of a facsimile MFP 1. The facsimile MFP 1 includes a Central Processing Unit (CPU) 2, a Read Only Memory (ROM) 3, a Random Access Memory (RAM) 4, an image memory 5, a modem 6, a Network Control Unit (NCU) 7, a codec 8, a scanner unit 9, a printer unit 10, a display unit 11, an operation unit 12 and a Local Area Network (LAN) interface 13. Each of the units 2 through 13 is connected by a bus 14.

The CPU 2 functions as a control unit which controls each of the units of the facsimile MFP 1 in accordance with a control program stored in the ROM 3. The ROM 3 stores the control program or the like. The RAM 4 functions as a main memory and a working area or the like of the CPU 2. The RAM 4 stores a destination identifier table 4a, an identifier 4b of the facsimile MFP 1 and a value 4c of an IP address reacquired number of times “K” to be described later. The destination identifier table 4a stores a destination domain name (in place of the destination domain name, a destination e-mail address can be stored) and an identifier by associating to one another. A piece of information specific to each communication device assigned statically (non-changing) to each communication device is applied as the identifier. In the present embodiment, a telephone number (a facsimile number), which is a subscriber number of a Public Switched Telephone Network (PSTN), assigned to the communication device 1 is applied as the identifier.

The image memory 5 stores image data or the like compressed and encoded by the codec 8. The modem 6 modulates and demodulates transmission data and received data in accordance with, for example, the International Telecommunication Union-Telecommunications (ITU-T) Recommendation V.34 standard or anything similar to this. The NCU 7 is a communication network control device which carries out an operation to close and release a communication line with a PSTN 15. According to necessity, the NCU 7 connects the modem 6 to the PSTN 15. The codec 8 compresses and encodes image data for a facsimile transmission or the like in accordance with a Joint Photographic Experts Group (JPEG) method or a Modified Huffman (MF), Modified Read (MR) or a Modified MR (MMR) method or the like. The codec 8 also decodes received image data or the like.

The scanner unit 9 scans image data of an original document. For example, the scanner unit 9 includes a Charge Coupled Device (CCD) color line sensor, an Analog-to-Digital (A/D) converter and an image processing circuit or the like. The printer unit 10 takes out printing paper from a paper feed cassette and prints received image data, scanned image data or the like onto the printing paper. The display unit 11 is configured from a Liquid Crystal Display (LCD), which is provided next to the operation unit 12, and displays various pieces of screen information. The operation unit 12 includes various operation keys or the like. A user performs various operations from the operation unit 7.

The LAN interface 13 is an interface for establishing a connection between the facsimile MFP 1 and a LAN 16. The facsimile MFP 1 carries out a communication through the LAN interface 13 with a client Personal Computer (PC) (not shown) and a router 19, which are also connected to the LAN 16. The facsimile MFP 1 also carries out a communication through the router 19 with another communication device on the Internet 17.

The above-described facsimile MFP 1 includes a Simple Mail Transfer Protocol (SMTP) server function, and also an Internet facsimile communication function which attaches image data of an original document or the like to electronic mail and transmits and receives the electronic mail. The facsimile MFP 1 also includes a G3 facsimile communication function which transmits and receives the image data of the original document or the like through the PSTN 15.

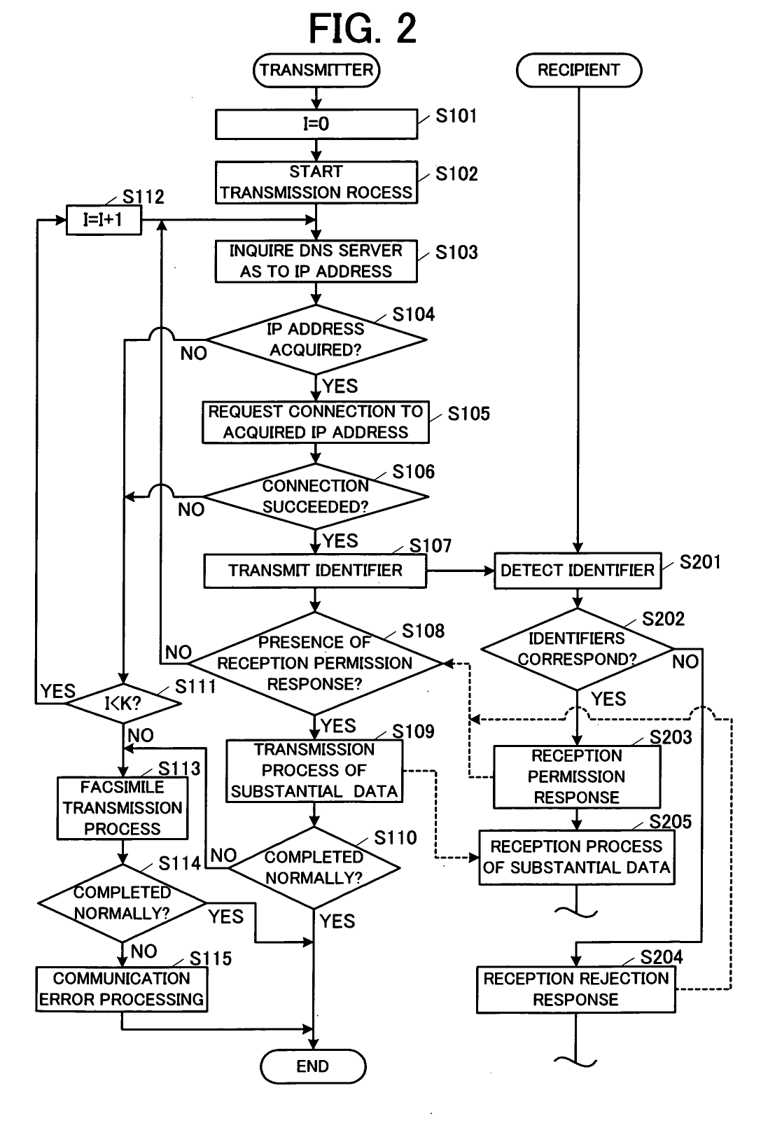

Next, referring to the flowchart shown in FIG. 2, a description will be made of a processing operation when the facsimile MFPs 1 having the above-described configuration and functions transmit and receive substantial data such as image data by an Internet facsimile with one another. Further, the processing operation to be described with reference to the flowchart of FIG. 2 is executed in accordance with a command generated by the CPU 2, which is a control unit, based on the control program stored in the ROM 3 or the like of each of the facsimile MFPs 1. In the specification and the claims, data including a substantial content to be transmitted from a transmitter to a recipient, such as electronic mail and image data, will be referred to as substantial data.

In the following, for convenience of the description, the facsimile MFP 1 to be a transmitter of the substantial data will be referred to as a transmitter facsimile MFP 1A. The facsimile MFPs 1 to be a recipient of the substantial data will be referred to as a recipient facsimile MFP 1B or 1C. A description will be made of an example when the transmitter facsimile MFP 1A carries out a connection process to an IP address acquired by presenting a destination domain name “ROUTER2.COM” of the recipient facsimile MFP 1B by using the dynamic DNS service 18.

In the transmitter facsimile MFP 1A, when the user or the like designates a destination e-mail address and instructs to start a transmission process of the substantial data, in the RAM 4, “0” is set for a variable “I” (step S101). Then, a transmission process such as a scanning process of image data of an original document set on the scanner unit 3 starts (step S102).

Next, the transmitter facsimile MFP 1A presents a domain name of the destination e-mail address to the dynamic DNS service 18 and inquires an IP address corresponding to the presented domain name (step S103). In case the transmitter facsimile MFP 1A acquires an IP address from the dynamic DNS service 18 (step S104: YES), the transmitter facsimile MFP 1A carries out a connection request through a destination router 20 or 21, which is assigned with the acquired IP address, to the recipient facsimile MFP 1B or 1C, which is connected to the destination router 20 or 21 (step S105). In case a connection is established with the recipient facsimile MFP 1B or 1C (step S106: YES), an identifier stored in the destination identifier table 4a by being associated with the domain name presented to the dynamic DNS service 18 at step S103 is transmitted to the connected recipient facsimile MFP 1B or 1C (step S107). Further, at step S107, an identifier registered in the destination identifier table 4a is applied for the identifier transmitted to the recipient facsimile MFP 1B or 1C. However, the user can designate the identifier from the operation unit 12 or the like accompanying a transmission operation and the designated identifier can be transmitted in place of the identifier registered in the destination identifier table 4a. In case the identifier is a telephone number, the identifier can be designated easily from a telephone number that the user remembers or from a telephone directory registered in the facsimile MFP 1.

In case the transmitter facsimile MFP 1A receives a prescribed reception permission response as a response to the identifier transmitted at step S107 (step S108: YES), the transmitter facsimile MFP 1A generates substantial data such as image data of an original document scanned by the scanner unit 9 and transmits the generated substantial data to the recipient facsimile MFP 1B (step S109). In case a transmission process of the substantial data is completed normally (step S110: YES), a series of processing operations are completed. Meanwhile, in case the transmitter facsimile MFP 1A receives a prescribed reception rejection response as a response to the identifier transmitted at step S107 (step S108: NO), the process returns to step S103. Further, at step S108, an absence of the reception permission response is determined in case of receiving a prescribed reception rejection response. However, an absence of the reception permission response can be determined in case a prescribed reception permission response is not detected within a prescribed period of time.

In case the transmitter facsimile MFP 1A fails to acquire an IP address at step S104 (step S104: NO), and in case the transmitter facsimile MFP 1A fails to establish a connection with the recipient facsimile MFP 1B or 1C at step S106 (step S106: NO), a determination is made as to whether the variable “I” is less than the value 4c of the IP address reacquired number of times “K” stored in the RAM 4 (step S111). In case the variable “I” is less than “K” (step S111: YES), “1” is added to the variable “I” (step S112) and the processing operation returns to step S103. Further, as a case in which the transmitter facsimile MFP 1A fails to acquire an IP address at step S104 and a case in which the transmitter facsimile MFP 1A fails to establish a connection with the recipient facsimile MFP 1B or 1C, for example, there is a case in which an error generates in the destination router 20 or 21, an access of the destination router 20 or 21 and the dynamic DNS service 18 (the DHCP server 18b) is disconnected and an IP address assigned to the router 20 or 21 by the dynamic DNS service 18 (the DHCP server 18b) is set under an available state.

In case the variable “I” is equal to or greater than the value 4c of the IP address reacquired number of times “K” stored in the RAM 4 at step S111 (step S111: NO), and in case the transmitter facsimile MFP 1A fails to carry out a transmission process of the substantial data normally at step S110 (step S110: NO), the identifier stored in the destination identifier table 4a by being associated with the domain name presented to the dynamic DNS service 18 at step S103 is designated as a destination facsimile number and a transmission process of the image data of the original document scanned by the scanner unit 9 is carried out to the recipient facsimile MFP 1B by the G3 facsimile communication (step S113). In case the facsimile transmission process is completed normally (step S114: YES), a series of processing operations are completed. In case the facsimile transmission process fails to be completed normally (step S114: NO), a communication error processing is carried out (step S115). For example, a communication error report is printed out from the printer unit 10 or a communication error message is displayed on the display unit 11.

Meanwhile, the recipient facsimile MFP 1B or 1C detects an identifier from the data received from the transmitted facsimile MFP 1A (step S201). In addition, a determination is made as to whether or not the detected identifier and the identifier 4b stored in the RAM 4 of the recipient facsimile MFP 1B or 1C correspond with one anther (step S202).

In case the recipient facsimile MFP is the facsimile MFP 1B having the domain name (“ROUTER2.COM”) presented to the DNS service 18 by the transmitter facsimile MFP, the identifier 4b stored in the recipient facsimile MFP 1B and the identifier received from the transmitter facsimile MFP 1A correspond with one another (step S202: YES). The recipient facsimile MFP 1B returns a prescribed piece of information as the reception permission response to the transmitter facsimile MFP 1A (step S203).

In case the recipient facsimile MFP is the facsimile MFP 1C having a domain name (“ROUTER3.COM”), which is different from the domain name (“ROUTER2.COM”) presented to the DNS service 18 by the transmitter facsimile MFP, the identifier 4b stored in the recipient facsimile MFP 1C and the identifier received from the transmitter facsimile MFP 1A do not correspond with one another (step S202: NO). Therefore, the recipient facsimile MFP 1C returns a prescribed piece of information (information that differs from the information returned at the reception permission response) as a reception rejection response to the transmitter facsimile MFP 1A (step S204). Further, at step S204, a prescribed piece of information is returned to the transmitter facsimile MFP 1A as the reception permission response. However, as described above, in case the transmitter facsimile MFP 1A determines an absence of the reception permission response at step S108 when a prescribed reception permission response has not been received within a prescribed period of time, the processing operation of step S204 is omitted.

As described above, according to the facsimile MFP 1 of an embodiment of the present invention, during a period of time from when a dynamic IP address is acquired by the dynamic DNS service until when a connection is established with a recipient communication device, even in case a destination communication device assigned with the acquired dynamic IP address switches from the facsimile MFP 1B to another facsimile MFP 1C, the transmitter facsimile MFP 1A can detect that the connected destination facsimile MFP 1C has switched with the initial facsimile MFP 1B having the acquired IP address in accordance with a reception of the reception rejection response or an absence of the reception permission response, and can stop the transmission of the substantial data. Therefore, an error transmission of the substantial data, which has generated conventionally, can be prevented.

In case of an absence of the reception permission response at step S108, in case of failing to acquire an IP address at step S104 and in case of failing to establish a connection with the destination at step S106, the transmitter facsimile MFP 1A returns the processing procedure to step S103 and attempts to reacquire the dynamic IP address. Therefore, at a point of time when the destination router 20 recovers from an error and the destination router 20 establishes a connection with the dynamic DNS service 18 (the DHCP server 18b), the transmitter facsimile MFP 1A can automatically start a communication with the facsimile MFP 1B, which is connected to the destination router 20. As a result, an operation of the user for a retransmission can be omitted. Moreover, in case the destination router 20 does not recover from an error within a prescribed period of time, data of an original document (substantial data) is transmitted automatically to the destination facsimile MFP 1B by the G3 facsimile communication. Therefore, even when a failure generated in a network at the transmitter or the recipient does not recover for a long period of time, data of an original document can be transmitted reliably to a destination facsimile MFP.

In the above-described embodiment, a description has been made of a case in which the transmitter communication device 1A acquires a dynamic IP address of a destination communication device by the dynamic DNS service and carries out a communication. However, the dynamic DNS service 18 may be a static DNS service, and the transmitter communication device may acquire a static IP address as the IP address of the destination communication device and execute the same processing operation as described above. Accordingly, for example, during a period of time from when the transmitter communication device 1A acquires the IP address of the destination communication device by the static DNS service until when the transmitter communication device 1A establishes a connection with the destination communication device, even in case the IP address of the destination communication device is changed to another IP address by a change in the setting or the like, if the identifier is not changed, an error transmission is prevented.

Further, the control program, which the CPU 2 fetches from the ROM 3 and executes for executing the processing operations (steps S101 through S115 and steps S201 through S205) of the facsimile MFP 1, can be embedded in a facsimile communication software for a computer (for example, a PC) and execute the same processing operations as the facsimile MFP 1 described above.

In the above-described embodiment, a description has been made of an example of the Internet facsimile communication by the SMTP as one example of the IP communication. If the communication device is a communication device which carries out a data communication by using the dynamic DNS service, another communication protocol may be used.

1. A communication device, comprising:
means for acquiring an Internet Protocol (IP) address by presenting a domain name of a destination communication device by using a Domain Name System (DNS) service;
means for transmitting an identifier assigned statically to the destination communication device, which is assigned with the IP address acquired by the means for acquiring, by establishing a connection with the destination communication device; and
means for transmitting substantial data to the destination communication device in case of receiving a reception permission response for the identifier from the destination communication device.

2. The communication device according to claim 1, wherein the DNS service is a dynamic DNS service and the IP address is a dynamic IP address.

3. The communication device according to claim 1, wherein the DNS service is a static DNS service and the IP address is a static IP address.

4. The communication device according to claim 1, further comprising means for communicating via a public communication network,
wherein the identifier is a telephone number for the public communication network.

5. The communication device according to claim 4, wherein in case of not receiving the reception permission response for the identifier from the destination communication device, the means for communicating transmits the substantial data to the destination communication device.

6. The communication device according to claim 4, wherein in case of receiving a reception rejection response for the identifier from the destination communication device, the means for communicating transmits the substantial data to the destination communication device.

7. The communication device according to claim 1, further comprising means for designating the identifier accompanying a transmission operation.

8. A communication device, comprising:
means for storing an identifier assigned statically to the communication device;
means for detecting an identifier from received data; and
means for replying a reception permission response to a transmitter communication device of a received identifier in case the detected identifier and the identifier stored by the means for storing correspond with one another.

9. The communication device according to claim 8, further comprising means for communicating via a public communication network;
wherein the identifier is a telephone number for the public communication network.

10. A communication method, comprising the steps of:
acquiring an Internet Protocol (IP) address by presenting a domain name of a destination communication device by using a Domain Name System (DNS) service;
establishing a connection with the destination communication device assigned with the acquired IP address, and transmitting a statically assigned identifier to the destination communication device; and
transmitting substantial data to the destination communication device in case of receiving a reception permission response for the identifier from the destination communication device.

11. The communication method according to claim 10, wherein the DNS service is a dynamic DNS service and the IP address is a dynamic IP address.

12. The communication device according to claim 10, wherein the DNS service is a static DNS service and the IP address is a static IP address.

13. The communication device according to claim 10, wherein the identifier is a telephone number for a public communication network.

14. The communication device according to claim 13, wherein in case of not receiving the reception permission response for the identifier from the destination communication device, the substantial data is transmitted to the destination communication device via the public communication network.

15. The communication device according to claim 13, wherein in case of receiving a reception rejection response for the identifier from the destination communication device, the substantial data is transmitted to the destination communication device via the public communication network.
